(19) United States
(12) Patent Application Publication
(10) Pub. No.: US 2026/0270526 A1
(43) Pub. Date: Sep. 10, 2026

(54) METHOD FOR SUPPORTING AUTOMATIC ADJUSTMENT OF PROJECTION AREAS AND SYSTEM THEREFOR

(71) Applicant: CJ 4DPLEX CO., LTD., Seoul (KR)

(72) Inventors: Kyoung Hwan KIM, Seoul (KR); Seong-Pil HYUN, Seoul (KR); Dae-Hyun WI, Seoul (KR); Na-Hyun KIM, Seoul (KR); Bum Ki KIM, Seoul (KR); Seung Hwa JEONG, Seoul (KR)

(21) Appl. No.: 19/650,247

(22) Filed: Apr. 16, 2026

Related U.S. Application Data
(63) Continuation of application No. PCT/KR2024/016110, filed on Oct. 22, 2024.

(30) Foreign Application Priority Data
Oct. 23, 2023 (KR) 10-2023-0142427

(51) Int. Cl. H04N 21/485; H04N 9/31; H04N 21/214; H04N 21/414; H04N 21/431; H04N 23/62

(52) U.S. Cl. CPC H04N 21/4858; H04N 9/3147; H04N 9/3185; H04N 21/2143; H04N 21/41415; H04N 21/431; H04N 23/62

(57) ABSTRACT

The present invention relates to a method and system for supporting the automatic adjustment of projection area. Specifically, the present invention relates to a method and system that allow a management server to automatically adjust a projection device based on a projection area scanned by a camera when an administrator (user) wishes to adjust the projection area of the projection device within a theater.

### CROSS REFERENCE TO RELATED APPLICATION(S)

This application is a continuation application under 35 U.S.C. 120, claiming a priority and benefit of International Application No. PCT/KR2024/016110 filed on Oct. 22, 2024, claiming priority based on Korean Patent Application No. 10-2023-0142427 filed on Oct. 23, 2023, the disclosure of which are incorporated herein by reference in their entirety.

### TECHNICAL FIELD

The present invention relates to a method and system for supporting the automatic adjustment of projection areas. Specifically, the present invention relates to a method and system that allow a management server to automatically adjust a projection device based on a projection area scanned by a camera when an administrator (user) wishes to adjust the projection area of the projection device within a theater.

### BACKGROUND ART

A theater is essentially equipped with a projection surface where a screen is projected and a projection device that projects the screen. If the position of the projection area displayed on the projection surface is misaligned, the person (administrator) managing the theater usually adjusts the installation position and orientation of the projection device directly or controls the projection device to adjust various parameters to align the projection area correctly.

However, in recent theaters, many designs that utilize multiple projection devices to enhance immersion have become increasingly common, making it difficult to continuously adjust the multiple projection devices. Moreover, in modern theaters, vibrations caused by loud sound effects during movie playback often result in the misalignment of the projection devices, making it challenging to manually adjust the projection areas.

The present invention has been proposed in light of these issues, with the aim of significantly increasing the management efficiency of a theater by enabling the automatic adjustment of one or more projection devices within a theater, and also improving the quality of services provided in the theater.

### DISCLOSURE

### Technical Problem

Therefore, an object of the present invention is to assist a user in easily adjusting a projection area, which is an output area projected by a projection device.

In particular, another object of the present invention is to increase the management efficiency of a theater by enabling the automatic adjustment of a projection area of each of multiple projection devices provided within a theater.

Still another object of the present invention is to allow a user with limited theater management experience to easily adjust the projection area through an intuitive interface.

Meanwhile, the above-mentioned objects of the present invention are not limited to those mentioned above, and other objects not mentioned will be clearly understood by those skilled in the art from the following description.

### Technical Solution

To solve the aforementioned issues, an embodiment of the present invention provides a method for supporting the automatic adjustment of projection areas, comprising: (a) a camera setup step of providing a camera setup interface for setting up a camera, which is intended to capture a projection environment including any projection surface, and receiving a camera setup input from a user; (b) a display setup step of providing a display setup interface for setting up a projection device to output an image onto the projection surface and receiving a display setup input from the user; (c) a projection environment scanning step of providing a scanning interface to allow the projection surface containing the image to be scanned by the camera while the image is output on the projection surface and receiving a scanning start input from the user; and (d) a projection area adjustment step of adjusting parameters of the projection device by utilizing a scanned image obtained by the scanning, and generating reference data.

Moreover, the method for supporting the automatic adjustment of projection areas may further include, after step (d), (e) a step of receiving an automatic projection area adjustment start input; (f) a step of determining whether there is previously stored reference data; and (g) if it is determined that there is reference data, a step of adjusting the parameters of the projection device using the reference data.

Furthermore, according to the method for supporting the automatic adjustment of projection areas, the projection environment may be an environment where multiple projection devices project videos across multiple projection surfaces.

In addition, according to the method for supporting the automatic adjustment of projection areas, the camera setup input may include the number of cameras and the shooting direction of each camera.

Additionally, according to the method for supporting the automatic adjustment of projection areas, the display setup input may include a projection device identifier and a projection device resolution.

Moreover, according to the method for supporting the automatic adjustment of projection areas, the projection area where the image is displayed may be included within a projectable area that can be displayed by the projection device.

Furthermore, the method for supporting the automatic adjustment of projection areas may further include, after step (c) and before step (d), a step of providing a manual adjustment interface for manual adjustment of the projection area after the scanning, and receiving a manual adjustment input from the user, wherein step (d) may adjust the parameters of the projection device by utilizing the reference data stored after the manual adjustment input.

In addition, the method for supporting the automatic adjustment of projection areas may further include, after step (a) and before step (b), a step of receiving a request input from the user to check the operating status of the camera; and a step of outputting a video captured by the camera.

Another embodiment of the present invention provides a management server including a central processing unit and a memory, wherein the central processing unit may execute instructions stored in the memory for performing a method for supporting the automatic adjustment of projection areas, wherein the method for supporting the automatic adjustment of projection areas may include: (a) a camera setup step of providing a camera setup interface for setting up a camera, which is intended to capture a projection environment including any projection surface, and receiving a camera setup input from a user; (b) a display setup step of providing a display setup interface for setting up a projection device to output an image onto the projection surface and receiving a display setup input from the user; (c) a projection environment scanning step of providing a scanning interface to allow the projection surface containing the image to be scanned by the camera while the image is output on the projection surface and receiving a scanning start input from the user; and (d) a projection area adjustment step of adjusting parameters of the projection device by utilizing a scanned image obtained by the scanning, and generating reference data.

Moreover, according to the management server, the method for supporting the automatic adjustment of projection areas may further include, after step (d), (e) a step of receiving an automatic projection area adjustment start input; (f) a step of determining whether there is previously stored reference data; and (g) if it is determined that there is reference data, a step of adjusting the parameters of the projection device using the reference data.

### Advantageous Effects

According to the present invention, even if there are fluctuations in the orientation of the projection device that cause the projection area to deviate from the normal area, the user can easily adjust the projection area through an intuitive interface.

Moreover, according to the present invention, if the projection area has been initially adjusted at least once, it enables automatic adjustment of the projection area in accordance with the reference data.

Furthermore, according to the present invention, even in an environment where multiple projection devices output multiple projection areas within a theater, it enables very rapid adjustments of all the projection devices.

Meanwhile, the above-mentioned effects of the present invention are not limited to those mentioned above, and other technical effects not mentioned will be clearly understood by those skilled in the art from the following description.

### DESCRIPTION OF DRAWINGS

FIG. 1 is a schematic diagram of a system for supporting the automatic adjustment of projection areas according to the present invention.

FIG. 2 illustrates the steps for performing the initial adjustment in a method for supporting the automatic adjustment of projection areas according to the present invention.

FIG. 3 illustrates the steps for performing the automatic adjustment upon completion of the initial adjustment.

FIG. 4 illustrates an example of a camera setup interface for receiving camera setup inputs.

FIG. 5 illustrates how the videos being captured by each camera are displayed to the user when checking the camera operation status.

FIG. 6 illustrates an example of a display setup interface for receiving display setup inputs.

FIG. 7 illustrates how identification numbers matching each projection area are displayed on the projection surface when receiving display setup inputs from the user.

FIG. 8 illustrates an example of a manual adjustment interface that allows the user to manually adjust the projection area.

FIG. 9 illustrates an example where the vertices of the projection area are displayed on any projection surface.

FIG. 10 illustrates an example of an interface provided to a user when attempting to automatically adjust the projection area.

FIGS. 11A and 11B illustrate cases where the adjustment of the projection area is possible and where it is not.

### MODE FOR INVENTION

Details regarding the objects and technical features of the present invention and the resulting effects will be more clearly understood from the following detailed description based on the drawings attached to the specification of the present invention. Preferred embodiments according to the present invention will be described in detail with reference to the attached drawings.

The embodiments disclosed in this specification should not be construed or used as limiting the scope of the present invention. It is obvious to those skilled in the art that the description, including the embodiments, of this specification has various applications. Therefore, any embodiments described in the detailed description of the present invention are illustrative to better illustrate the present invention and are not intended to limit the scope of the present invention to the embodiments.

The functional blocks shown in the drawings and described below are only examples of possible implementations. In other implementations, different functional blocks may be used without departing from the spirit and scope of the detailed description. Moreover, although one or more functional blocks of the present invention are shown as individual blocks, one or more of the functional blocks of the present invention may be a combination of various hardware and software components that perform the same function.

Furthermore, the term “comprising” certain components, which is an “open-ended” term, simply refers to the presence of the corresponding components, and should not be understood as excluding the presence of additional components.

In addition, if a specific component is referred to as being “connected” or “coupled” to another component, it should be understood that it may be directly connected or coupled to another other component, but there may be other components therebetween.

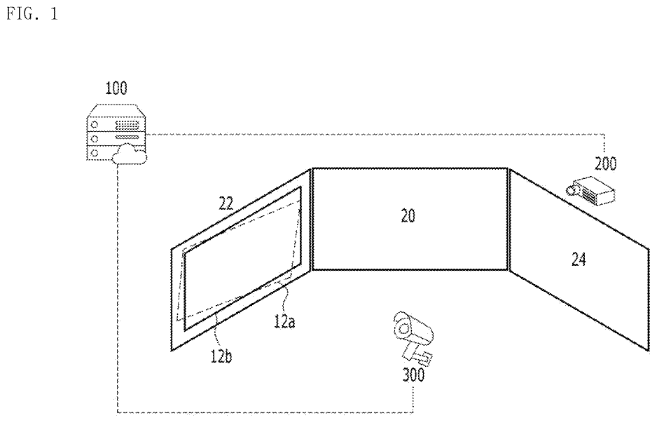

FIG. 1 is a schematic diagram illustrating the entire system required to support the automatic adjustment of projection areas according to the present invention. Referring to FIG. 1, it is assumed that the system according to the present invention is provided in a theater equipped with at least one projection surface, preferably multiple projection surfaces 20, 22 and 24 as shown in the drawing, and the system includes at least a management server 100, one or more projection devices 200, and one or more cameras 300.

Before providing a detailed description of each component, a representative embodiment of the present invention will be described with reference to FIG. 1.

There are many tasks involved in theater management, among which adjusting the projection area to ensure that the correct projection area is displayed on the projection surface is a very important task. The projection device(s) 200 are typically installed securely at specific locations facing the projection surfaces (such as a screen, wall, etc.). However, even when installed firmly, the initial installation position of the projection device may become misaligned due to various reasons. As a result, the projection area can also be affected, leading to screen tilting or gaps between the connection areas of adjacent projection areas, making it difficult for the audience to enjoy the movie properly.

The present invention is intended to correct the misalignment of the projection area caused by changes in the orientation of the projection device by performing a projection environment scanning process using a camera 300. The drawing shows a camera 300 positioned to fact the left projection surface 22 with its shooting angle directed towards it. The camera 300 functions to scan the projection area output from the projection device 200. The scanned scan image obtained in this way, along with the parameter values of the projection area that can be obtained by analyzing the scanned image, can be used to control the projection device 200 to ensure that the projection area is output correctly to the normal area. For reference, FIG. 1 illustrates the process of adjusting the projection area 12a before the adjustment to the normal projection area 12b within the left projection surface 22.

Meanwhile, as will be described again later, the method for supporting the automatic adjustment of projection areas according to the present invention can utilize the automatic adjustment of projection areas only after the initial adjustment step and the generation of reference data. Since the accuracy and reliability of the reference data used in the automatic adjustment must be high for subsequent automatic adjustments to be carried out accurately, the user's input and operation in the initial adjustment step are very important. The interfaces used in the initial adjustment step will be described in detail later.

Referring gain to FIG. 1, the system for supporting the automatic adjustment of projection areas according to the present invention may include a management server 100, a projection device 200, and a camera 300 as the main components, which will now be described in detail.

The management server 100 is a computing device that can be operated by a person in charge of managing or operating the theater. It is connected to the main electronic devices in the theater via a network, allowing for control over each electronic device. The management server 100 according to the present invention can preferably be connected to the projection devices 200 and the camera 300 via a network, allowing for remote control of the projection devices 200 and the cameras 300 when control commands are input via the management server 100. Moreover, the management server 100 can provide the theater administrator, i.e., the user, with interfaces for supporting the automatic adjustment. In this case, the management server 100 can provide these interfaces to the user either via an output device such as a monitor directly connected to the management server 100, or through a portable terminal such as a smart phone connected to the management server 100 via a network. Furthermore, in some cases, the management server 100 may have the function and authority to output movie content onto the projection surfaces within a theater, and in this case, the user can execute the automatic projection area adjustment function in advance each time the movie content is screened, ensuring that the audience enjoys high-quality visuals every time the video is screened.

For reference, it is assumed that the management server 100 includes a central processing unit and a memory. In this case, the central processing unit can also be referred to as a controller, microcontroller, microprocessor, microcomputer, etc. Moreover, the central processing unit can be implemented in hardware, firmware, software, or a combination thereof. When it is implemented using hardware, it can take the form of an application specific integrated circuit (ASIC), a digital signal processor (DSP), a digital signal processing device (DSPD), a programmable logic device (PLD), or a field programmable gate array (FPGA), and when it is implemented using firmware or software, the firmware or software can be configured to include modules, procedures, or functions that perform the above-mentioned functions or operations. Furthermore, the memory can be implemented using a memory such as a Read Only Memory (ROM), Random Access Memory (RAM), Erasable Programmable Read-Only Memory (EPROM), Electrically Erasable Programmable Read-Only Memory (EEPROM), flash memory, Static RAM (SRAM), Hard Disk Drive (HDD), or Solid State Drive (SSD). There is no limitation on the type of hardware required to implement the management server 100. For example, server computers, portable terminals (laptop computers, smartphones, etc.), desktop computers, etc. are representative examples of computing devices. In addition, in some cases, the management server 100 may be available in the form of a cloud server.

Next, the projection device 200 refers to a device for projecting videos, also known as a projector. Multiple projection devices 200 can be installed in a theater, with each projection device positioned to project video onto opposing projection surfaces. The types of projection devices 200 include, but are not necessarily limited to, those implemented with CRT, LCD, and DLP technologies. In the case of multiple projection devices 200, at least some of the projection devices may be available from different manufacturers based on different principles, and each of the projection devices 200 can be independently connected to the management server 100 via a network. If necessary, the management server 100 can cluster several projection devices 200 to control them as a single group; however, each projection device 200 is fundamentally connected to the management server 100 independently. In addition, parameters related to content output can be adjusted in the projection device 200. For example, adjustments can be made to brightness (light source intensity of the projection device), contrast (difference between light and dark), color temperature, focus, zoom, or keystone correction.

Finally, the camera 300 is a device for capturing the projection environment, which refers to the space or environment that includes the projection surface when the projection device outputs any still image or video on that projection surface. More specifically, since the area that any camera 300 can capture does not exactly align with the projection surface, the projection environment is defined to include the space being captured, including the projection surface. In the projection environment, therefore, in addition to the projection surface, there may be installations, devices, or other objects included in the surrounding space. For example, the audience seats located around the projection surface, speakers installed on the projection surface, projection devices outputting videos on other projection surfaces, and cameras installed to scan (capture) other projection surfaces can all be included in the projection environment. Meanwhile, multiple cameras 300 can be installed within the theater, and each camera 300 can be positioned to capture images in a predetermined direction. A single camera 300 may be installed to capture a projection environment that includes multiple projection surfaces. Additionally, a single camera 300 may be set up to capture a state where multiple projection areas are displayed on a single projection surface, or it may be installed to capture a projection environment that includes a single specific projection surface. In this detailed description, it is assumed that the camera 300 is installed to be mapped to a specific projection surface to capture images; however, it is understood that this is not necessarily limiting.

Meanwhile, the camera 300 is generally used for scanning or capturing with a focus on the projection area, such as when capturing the projection environment where the projection area is normally projected onto the projection surface, or when the projection area is projected abnormally. However, if necessary, at least one of the shapes and positions of the surrounding installations and devices within the projection environment captured by the camera 300 may be referenced by the management server 100 to adjust the projection area later. For example, assuming that the projection environment is captured by any camera and the installation status of a specific projection device is also included in the captured projection environment, the management server 100 can adjust the output status or projection area of the projection device by comparing the captured installation status of the specific projection device with that of a specific projection device previously captured within the projection environment. On the other hand, the projection environment captured by the camera 300 can also be utilized by the management server 100 to determine whether the automatic adjustment of the projection area for a specific projection device is necessary within the theater. For example, if a specific projection device is captured by any camera at time intervals and the installation location of the projection device is analyzed to be different from a previously captured one, the management server 100 can initiate the automatic adjustment of the projection areas based on this information, and it can be performed automatically without requiring the user's start input.

As described above, the system required for supporting the automatic adjustment of projection areas according to the present invention and its associated devices have been discussed with reference to FIG. 1.

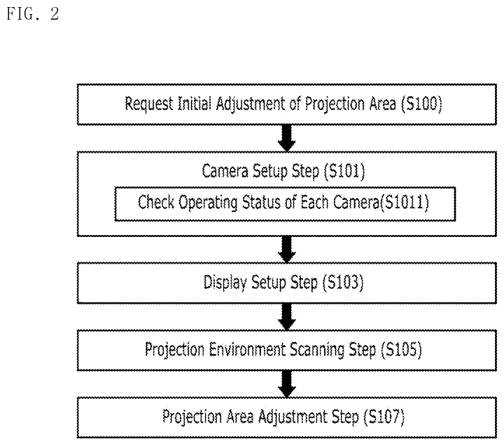

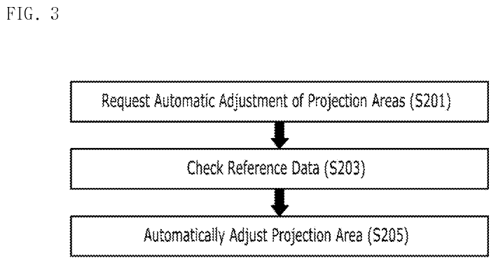

FIG. 2 illustrates the steps for performing the initial adjustment step in the method for supporting the automatic adjustment of projection areas according to the present invention, and FIG. 3 illustrates the steps for performing the automatic adjustment in sequence. For reference, FIGS. 2 and 3 illustrate a situation where the management server 100 receives inputs from the user and performs the adjustments based on the inputs. Below, each step of the method will be described in detail.

Referring to FIG. 2, the method for supporting the automatic adjustment of projection areas may start from a step (S100) in which the management server 100 receives a request from the user to perform the initial adjustment of the projection area. This step can be performed by the user executing a program for the automatic adjustment of the projection areas and then clicking on a button to initiate the projection area adjustment, or by inputting a projection area adjustment request.

After step S100, a camera setup step (S101) may be executed. In this step, a camera setup interface is provided to the user, allowing the user to input multiple camera settings through the camera setup interface.

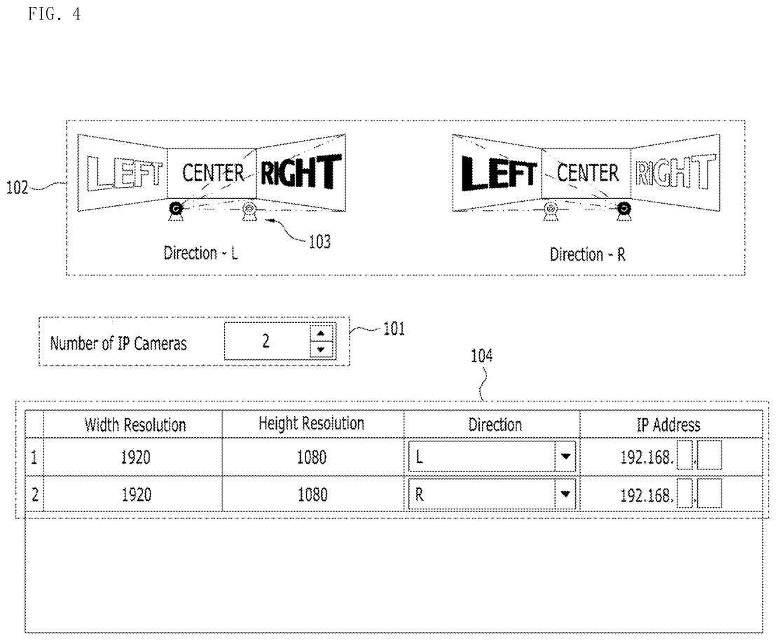

FIG. 4 illustrates an example of a camera setup interface. Referring to the drawing, at least the number of cameras, the direction of the camera, and the resolution of the camera can be input through the camera setup interface, and additionally, the IP addresses of each camera can also be input. The camera setup interface is configured intuitively to allow the user to easily input camera settings. It may include an area 101 for inputting the number of cameras, an area 104 for inputting the camera number, resolution, direction, and address. Additionally, it may further include a simulation area 102 that visually represents the projection relationship between the projection surface and the camera direction. The simulation area 102 is primarily used to display the appearance of the projection surfaces within the theater, the appearance of the cameras provided within the theater, and the directional orientation indicating which projection surface a specific camera is aimed at for capturing (scanning). Meanwhile, according to another embodiment, the simulation area 102 allows the user to freely change the position of the camera 103. Additionally, after clicking on the camera 103, the user can click on a specific projection surface to establish the mapping between the camera and the projection surface, i.e., the directional orientation. Specifically, the user can click on the camera 103 and drag it to directly determine the installation position of the camera 103 within the theater. Moreover, the user can also directly adjust the direction of the camera 103 to specify which projection surface it is aimed at, enabling an intuitive camera setup. The use of the simulation area 102 provides the user with a more intuitive way to set up the camera, compared to simply inputting the necessary values or texts in the areas 101 and 104. In particular, when similar types of devices (projection devices, projection surfaces, cameras) are installed in different directions and locations, the need for the simulation area 102 to output the theater state graphics, along with the position adjustment of the camera 103 and the mapping between the camera 103 and the projection surface, is very high in order to establish the complex relationships between these devices. These functions can help prevent confusion during user input.

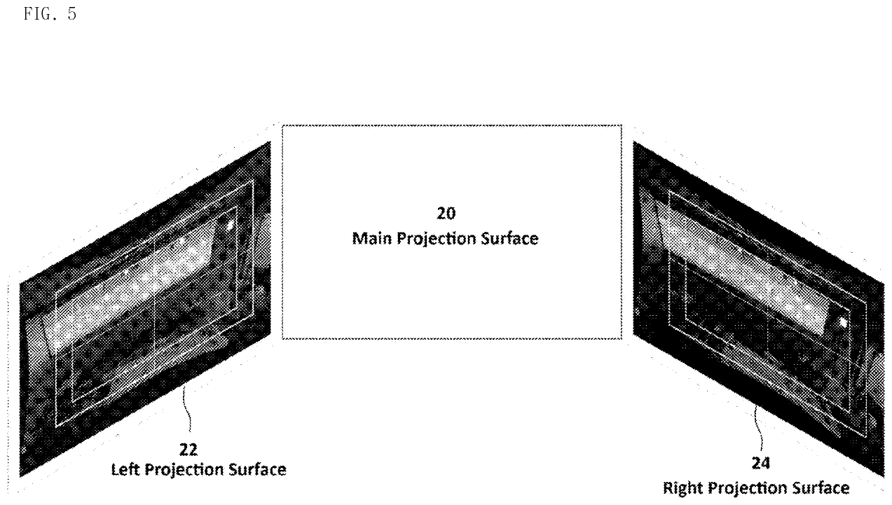

Meanwhile, the camera setup step (S101) may further include a step (S1011) for checking the operating status of each camera. The determination of the operating status can be achieved by displaying the real-time footage from each camera to the user. The management server 100 can display a message to the user after the settings for each camera are input, such as “Would you like to check the operating status of Camera # O?” for each camera based on its number. If the user inputs a confirmation request, the corresponding camera can display the video it is capturing in real time, i.e. the projection environment, on the screen. Meanwhile, referring to FIG. 5, the management server 100 can allow the user to intuitively check the operating status of each camera by displaying the operating status of each camera as shown in the drawing. FIG. 5 illustrates multiple projection surfaces provided in the theater, with real-time videos being output from the cameras corresponding to the left projection surface 22 and the right projection surface 24, respectively. The management server 100 not only allows the user to check the operating status of the camera by displaying it on the actual structure of the theater, but also enables the user to visually confirm the overall projection environment captured by the camera, especially the status of the projection area to be adjusted. Furthermore, by presenting the actual theater environment, it is possible to reduce the possibility of confusion throughout the entire workflow. For reference, nothing is displayed on the main projection surface 20 in FIG. 5; however, if necessary, the management server 100 can also output video content or still images for testing on the main projection surface 20, thereby simulating the actual screening environment within the theater.

Referring gain to FIG. 2, after step S101, a display setup step (S103) may be executed. In this step, a display setup interface may be provided to the user, allowing the user to input display settings.

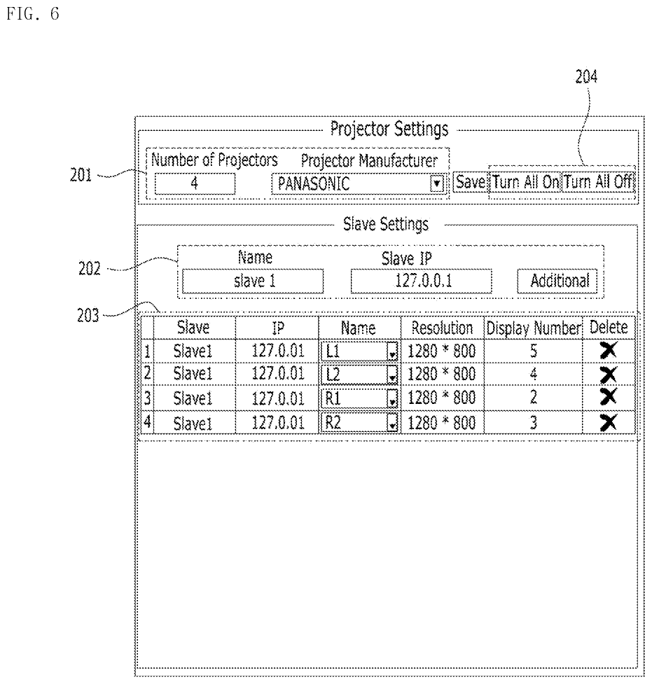

FIG. 6 illustrates an example of a display setup interface. Referring to the drawing, the display setup interface may include an area 201 for inputting the number of projection devices as well as the manufacturer of the projection device, an area 202 for inputting server information for any additional servers required to control the projection devices, an area 203 for displaying a list of the added projection devices and allowing the user to modify the information for each projection device based on user input, and further, a power input area 204 for controlling the on/off state of all projection devices.

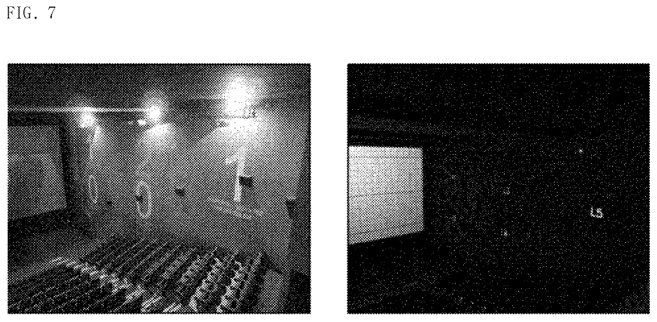

For reference, each projection device 200 may be assigned an identifier, which may include the name of the projection device, a number assigned to the projection device, or an image or symbol designated for the projection device. This identifier can also serve as a means to distinguish the projection areas when outputting the projection areas onto the projection surface within the theater. In other words, with the use of the identifier contained in the screen output by a specific projection device 200, it becomes easy to identify which projection device 200 is displaying the video on the projection surface. FIG. 7 illustrates the scenario within an actual theater where five projection devices are displaying five distinct projection areas onto the projection surface (the screening room wall). It can be seen that each projection area includes the corresponding identifier (number 1 to 5, L1 to L5, etc.) of the projection device.

Referring gain to FIG. 2, after step S103, a step (S105) of scanning the projection environment may be executed. This step is intended to control the cameras, whose settings and operating statuses have previously been checked, to capture the projection surface corresponding to each camera, and more precisely, to capture the projection environment that includes the projection surface. The management server 100 can display a message to the user such as “Would you like to scan the projection surface?” Once the user inputs a request to proceed, the management server 100 can control each camera to initiate the scanning of the projection environment. At this time, the management server 100 may either operate the cameras with a time delay between them or activate multiple cameras simultaneously to scan the projection surface. After the projection surface scan is completed, the video or image captured by each camera can be created as a scanned image, which can then be transmitted and shared with the management server 100.

After step S105, a projection area adjustment step (S107) may be executed. In this step, the management server 100 can refer to the previously shared scanned image to adjust the projection area, and more precisely, to adjust the parameters controllable from the projection device 200. In this step, the adjustments may preferably involve altering the shape or position of the projection area, such as tilting, panning, or keystone correction.

Meanwhile, the management server 100 can control each projection device 200 to adjust the projection area independently, allowing the projection area adjustment step to be carried out entirely automatically without user intervention. However, a manual adjustment interface may also be provided to allow the user to make manual adjustments if necessary. This manual adjustment interface may be provided to the user, for example, after the projection environment has been scanned by the camera or after the projection area has been adjusted. In the manual adjustment interface, the user can directly specify the projection area through click or touch input.

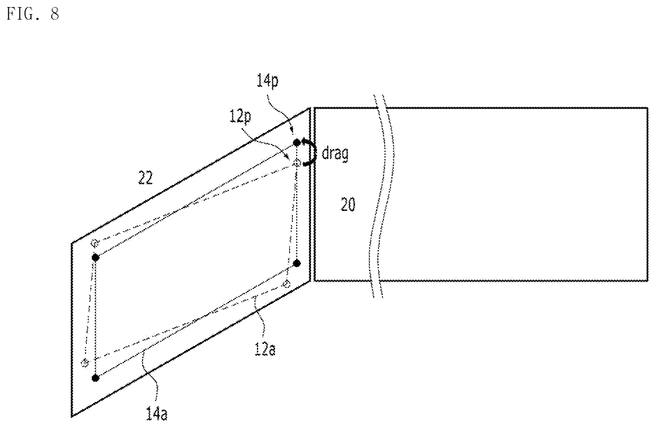

FIG. 8 illustrates an example of a manual adjustment interface. As shown in the drawing, the manual adjustment interface can virtually display the projection surfaces(s) of the theater and show the scanned image obtained through the projection environment scanning step on a specific projection surface, thereby allowing the user to directly adjust the projection area. The drawing assumes a scenario where the scanned image of the projection environment is displayed on the left projection surface 22, located on the left side of the main projection surface 20. On the left projection surface 22, the projection area 12a before the adjustment can be displayed along with the vertices 12p before the adjustment. In a state where this screen is given, the user can drag at least one of the vertices 12p before the adjustment to change its position, and the moved vertices can then be set as the vertices 14p after the adjustment. Once all the vertices have been moved to the positions desired by the user, the line segments connecting the vertices will form a single projection area, which will be referred to as the projection area 14a after the adjustment. FIG. 8 illustrates an example of a manual adjustment interface provided to a user after the projection environment scanning step. This manual adjustment interface may also be provided to the user even after the projection area adjustment is completed. After the projection area adjustment, the projection area derived from the adjustment by the management server 100 can be displayed on the projection surface of the manual adjustment interface. Assuming that this is referred to as the first adjusted projection area, the user can then drag and move the vertices of the first adjusted projection area to determine a second adjusted projection area.

Meanwhile, after the projection area adjustment is completed in step S107, so-called reference data may be generated and stored. The reference data refers to the information that serves as the basis for adjustments when the automatic adjustment of projection areas is executed by the management server 100 in the future. This data may include information on when the projection area is normally displayed on the projection surface after the initial adjustment is completed. The reference data may encompass all information stored during the projection area adjustment process. For example, it may include information about the theater, information about the projection device, cluster information, information about the image areas (projection areas), and information related to fine-tuning. In this manner, the reference data can be stored for each projection area, along with the corresponding information about the projection devices, or it can be integrated to store information about all projection areas across all projection surfaces, along with all corresponding projection devices.

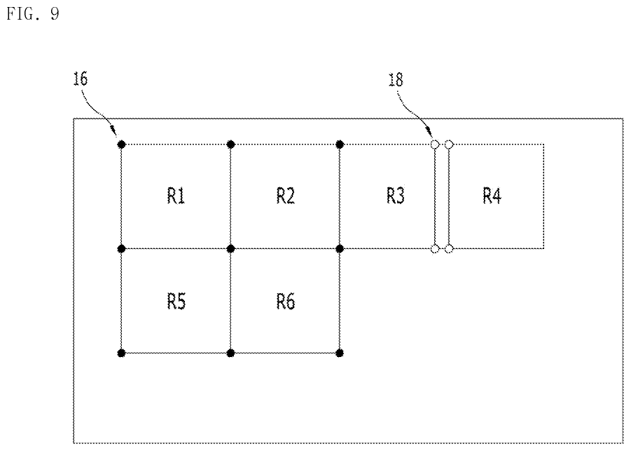

For reference, the information contained in the reference data may also include the location of each projection area and/or their overlapping states when multiple projection areas are displayed on the projection surface. Such information may preferably be included in the form of coordinates corresponding to the vertices 16 of each projection area. FIG. 9 is a virtual representation of the projection areas R1 to R6 being output on any projection surface, and the reference data may include the coordinates of four vertices of R1 or of four vertices of R6. Moreover, these coordinates can be distinguished to include the coordinates of some vertices of the projection areas that have overlapping areas and those of the projection areas that do not. It can be seen from FIG. 9 that the projection areas R3 and R4 overlap each other, with the vertices surrounding the overlapping area between R3 and R4 being indicated in white. The drawing of FIG. 9 is visualized to aid in understanding the present invention, and the actual reference data may include the coordinates of each vertex as numbers, letters, or a combination of numbers and letters. Furthermore, the vertices surrounding the overlapping area and the vertices of the projection areas that do not overlap can be distinguished and included as the coordinates in the reference data.

As described above, the initial adjustment step in the method for supporting the automatic adjustment of projection areas according to the present invention has been discussed with reference to FIGS. 2 to 9.

FIG. 3 illustrates an automatic adjustment method where the management server 100 refers to the pre-stored reference data to adjust the projection areas when the user requests the automatic adjustment of the projection areas after the initial adjustment is completed.

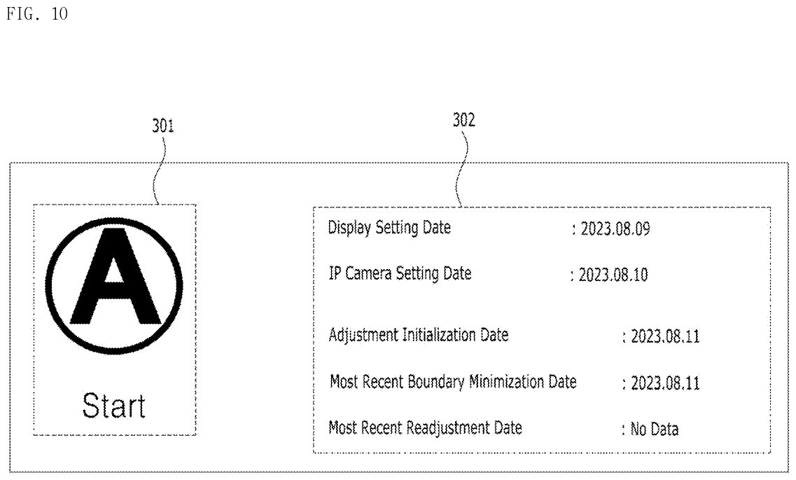

Referring to the drawing, the automatic adjustment method according to the present invention may first include a step (S201) in which the management server 100 receives an automatic adjustment request for the projection areas. This step can also be understood as the user directly inputting the automatic adjustment request through the management server 100. For example, an automatic adjustment request interface, as shown in FIG. 10, may be displayed to the user, which may include a start button 301 that can be clicked to initiate the automatic adjustment request, and an information display area 302 that displays information for the user to reference when making the automatic adjustment. The information that the user can reference may include the date when the last settings for the projection devices 200 were completed (Display Setting Date), the date when the last settings for the cameras 300 was completed (IP Camera Setting Date), and/or the date when the initial adjustment was last performed (Adjustment Initialization Date). Additionally, it may further include the dates of other functions additionally performed by the management server 100 (such as the Most Recent Boundary Minimization Date, the Most Recent Readjustment Date, etc.).

Meanwhile, step S201 may not necessarily involve the user's input action. As previously mentioned, the camera 300 can be implemented to periodically capture the projection environment. The management server 100 can receive the images of the projection environment captured in real time or periodically from one or more cameras 300, analyze these images to determine if there are changes in the projection areas, and if it is determined that the adjustment of the projection areas is necessary, initiate the automatic adjustment of projection areas immediately. In the modified embodiment, the step of the management server 100 determining the need for the adjustment of the projection area can directly replace the step of requesting the automatic adjustment of the projection areas (S201). This modified embodiment utilizes the camera 300 as a means to monitor the projection areas, allowing for the automatic initiation of the automatic adjustment of the projection areas when necessary.

After step S201, it is possible to check whether the pre-stored reference data exists (S203). The automatic adjustment of the projection areas can proceed only if there is reference data generated upon completion of the initial adjustment, and thus the existence of reference data should be checked in this step. If it is determined that reference data does not exist in this step, the management server 100 may provide the necessary user interfaces for the initial adjustment step to the user again, thereby prompting the creation of reference data based on the initial adjustment.

After step S203, a step in which the management server 100 automatically adjusts the projection area (S205) may be executed. This step can be understood as the management server 100 automatically performing calculations and adjustments; however, specifically, it can also be understood as a process of automatically performing a series of steps, including checking the settings of the camera, checking the settings of the projection device, scanning the projection environment or verifying the scanned images, and adjusting the projection areas with reference to the reference data.

As described above, the automatic adjustment step performed upon completion of the initial adjustment in the method for supporting the automatic adjustment of projection areas according to the present invention has been discussed with reference to FIGS. 3 and 10.

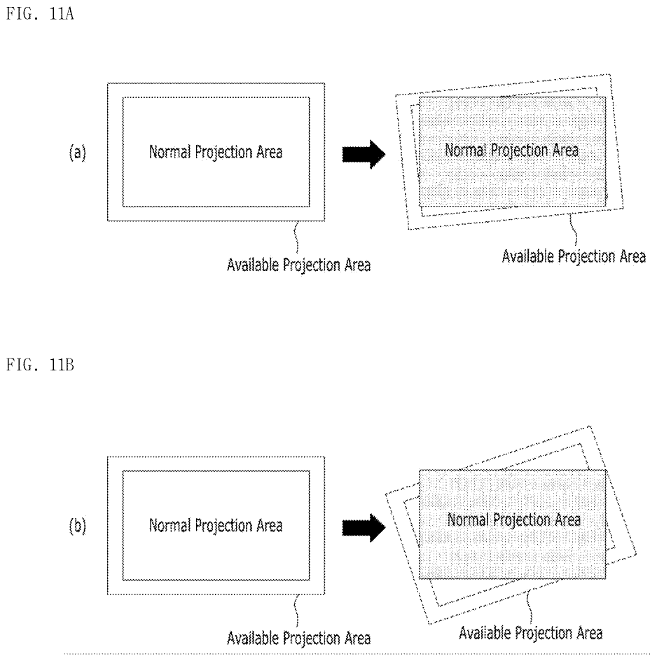

For reference, the method for supporting the automatic adjustment of projection areas according to the present invention aims to allow the projection device 200 to project the video onto the normal area, even if the orientation of the projection device 200 is misaligned. However, if the change in the orientation of the projection device 200 is too severe, there may be cases where the adjustment is not possible, regardless of how the parameters of the projection device 200 are controlled. According to the present invention, when the user requests the initial adjustment or automatic adjustment, a step may be included to first determine the possibility of adjusting the projection area before proceeding with the actual steps. This way, the initial adjustment or automatic adjustment will be carried out only if the adjustment is possible; otherwise, a message indicating that the adjustment is not possible can be displayed. Referring to FIGS. 11A and 11B, case (a) represents a situation where the adjustment of the projection area is possible. When the area that the projection device 200 can project onto any projection surface is referred to as the available projection area, if the orientation of the projection device 200 changes and both the projection area and the available projection area are tilted, but the normal projection area is still contained within the available projection area, the management server 100 can determine that the adjustment of the projection area is possible. Case (b) represents a situation where the adjustment of the projection area is not possible. If the orientation of the projection device 200 changes and the normal projection area deviates even slightly from the available projection area, the management server 100 can determine that the adjustment of the projection area is not possible. The determination of the possibility of adjusting the projection area can be made after the camera 300 captures the projection environment. For example, this determination can occur when the management server 100 analyzes the scanned image obtained in step S105 or when it analyzes the scanned image of the projection environment obtained during the automatic adjustment of the projection area in step S205. On the other hand, when utilizing the camera 300 as a means to monitor the projection area, the management server 100 can also be prompted to make such determination. For example, the camera 300 can be configured to capture (monitor) the projection environment at predetermined intervals (e.g., immediately after each movie content screening) and then share the captured video or image with the management server 100. This allows the management server 100 to periodically determine the possibility of adjusting the projection area.]

As described above, the method and system for supporting the automatic adjustment of projection areas have been discussed. Meanwhile, the present invention is not limited to the specific embodiments and applications described above, and various modifications can be made by those skilled in the art without departing from the gist of the present invention as claimed in the claims. These modified implementations should not be understood as being separate from the technical spirit or scope of the present invention.

1. A method for supporting the automatic adjustment of projection areas, comprising:
(a) a camera setup step of providing a camera setup interface for setting up a camera, which is intended to capture a projection environment including any projection surface, and receiving a camera setup input from a user;
(b) a display setup step of providing a display setup interface for setting up a projection device to output an image onto the projection surface and receiving a display setup input from the user;
(c) a projection environment scanning step of providing a scanning interface to allow the projection surface containing the image to be scanned by the camera while the image is output on the projection surface and receiving a scanning start input from the user; and
(d) a projection area adjustment step of adjusting parameters of the projection device by utilizing a scanned image obtained by the scanning, and generating reference data.

2. The method for supporting the automatic adjustment of projection areas according to claim 1, further comprising, after step (d),
(e) a step of receiving an automatic projection area adjustment start input;
(f) a step of determining whether there is previously stored reference data; and
(g) if it is determined that there is reference data, a step of adjusting the parameters of the projection device using the reference data.

3. The method for supporting the automatic adjustment of projection areas according to claim 1, wherein the projection environment is an environment where multiple projection devices project videos across multiple projection surfaces.

4. The method for supporting the automatic adjustment of projection areas according to claim 1, wherein the camera setup input includes the number of cameras and the shooting direction of each camera.

5. The method for supporting the automatic adjustment of projection areas according to claim 1, wherein the display setup input includes a projection device identifier and a projection device resolution.

6. The method for supporting the automatic adjustment of projection areas according to claim 1, wherein the projection area where the image is displayed is included within a projectable area that can be displayed by the projection device.

7. The method for supporting the automatic adjustment of projection areas according to claim 1, further comprising, after step (c) and before step (d),
a step of providing a manual adjustment interface for manual adjustment of the projection area after the scanning, and receiving a manual adjustment input from the user,
wherein step (d) adjusts the parameters of the projection device by utilizing the reference data stored after the manual adjustment input.

8. The method for supporting the automatic adjustment of projection areas according to claim 1, further comprising, after step (a) and before step (b),
a step of receiving a request input from the user to check the operating status of the camera; and
a step of outputting a video captured by the camera.

9. A management server for supporting the automatic adjustment of projection areas, the management server comprising a central processing unit and a memory, wherein the central processing unit executes instructions stored in the memory for performing a method for supporting the automatic adjustment of projection areas,
wherein the method for supporting the automatic adjustment of projection areas comprises: (a) a camera setup step of providing a camera setup interface for setting up a camera, which is intended to capture a projection environment including any projection surface, and receiving a camera setup input from a user;
(b) a display setup step of providing a display setup interface for setting up a projection device to output an image onto the projection surface and receiving a display setup input from the user;
(c) a projection environment scanning step of providing a scanning interface to allow the projection surface containing the image to be scanned by the camera while the image is output on the projection surface and receiving a scanning start input from the user; and
(d) a projection area adjustment step of adjusting parameters of the projection device by utilizing a scanned image obtained by the scanning, and generating reference data.

10. The management server according to claim 9, wherein the method for supporting the automatic adjustment of projection areas further comprises, after step (d),
(e) a step of receiving an automatic projection area adjustment start input;
(f) a step of determining whether there is previously stored reference data; and
(g) if it is determined that there is reference data, a step of adjusting the parameters of the projection device using the reference data.
